(19) United States
(12) Patent Application Publication
(10) Pub. No.: US 2019/0152036 A1
(43) Pub. Date: May 23, 2019

(54) HAMMER WITH NAIL PULLER

(71) Applicant: LU KANG HAND TOOLS INDUSTRIAL CO., LTD., FU HSING HSIANG (TW)

(72) Inventor: Yi-Kung HUNG, FU HSING HSIANG (TW)

(73) Assignee: LU KANG HAND TOOLS INDUSTRIAL CO., LTD., FU HSING HSIANG (TW)

(21) Appl. No.: 15/820,975

(22) Filed: Nov. 22, 2017

(51) Int. Cl. B25D 1/04; B25G 1/01

(52) U.S. Cl. CPC B25D 1/04; B25G 1/01

(57) ABSTRACT

A hammer has a main unit. The main unit has a handle, a striking head, and a nail puller. The handle has a lengthwise direction, a first end, and a second end. The first end of the handle and the second end of the handle are opposite in the lengthwise direction of the handle. The striking head is disposed at the first end of the handle. The nail puller is disposed at the second end of the handle. The nail puller has a pulling unit with an opening for receiving a nail. The nail puller is thinner than the striking head and allows the hammer to be operated in a small space to remove a fixed nail.

### BACKGROUND OF THE INVENTION

### 1. Field of the Invention

The present invention relates to a hammer, and more particularly to a hammer with a nail puller disposed opposite a striking head of the hammer that may extract a fixed nail in a small space.

### 2. Description of Related Art

A hammer is a well known tool that is utilized to strike or impact on an object such as a nail, a wedge, etc. There are many kinds of hammers designed for different purposes such as ball-peen hammers, point-peen hammers, and claw hammers. Among these hammers, the claw hammers are capable of removing a fixed nail. A conventional claw hammer has a handle and a striking head. The handle is a bar with two opposite ends. The striking head has a striking face, a claw, an eye, and a head length. The striking face and the claw face to opposite directions. The claw is designed for removing the fixed nail and has an opening for receiving the fixed nail. The eye of the striking head is formed through the striking head and is mounted and fixed on one of the ends of the handle. The head length is defined from the striking face to the claw of the striking head.

However, the conventional claw hammer is not suitable for removing nails fixed in a small space due to the head length. The head length of the conventional hammer makes the conventional claw hammer difficult to operate in the small space and interferes with its capability of removing nails.

To overcome the shortcomings of the conventional claw hammer, the present invention provides a hammer with a nail puller to mitigate or obviate the aforementioned problems.

### SUMMARY OF THE INVENTION

The main objective of the present invention is to provide an improved hammer that is suitable for extracting nails fixed in a small space.

The hammer comprises a main unit. The main unit has a handle, a striking head, and a nail puller. The handle has a lengthwise direction, a first end, and a second end. The first end of the handle and the second end of the handle are opposite in the lengthwise direction of the handle. The striking head is disposed at the first end of the handle. The nail puller is disposed at the second end of the handle. The nail puller has a pulling unit with an opening for receiving a nail. The nail puller is thinner than the striking head and allows the hammer to be operated in a small space to remove a fixed nail.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a first embodiment of a hammer in accordance with the present invention;

FIG. 2 is an exploded perspective view of the hammer in FIG. 1;

FIG. 3 is an enlarged side view of a handle of the hammer in FIG. 1;

FIG. 4 is a partially cross sectional perspective view of the hammer in FIG. 1;

FIG. 5 is an operational side view of the hammer in FIG. 1;

FIG. 6 is a partially exploded perspective view of a second embodiment of a hammer in accordance with the present invention;

FIG. 7 is a partially exploded perspective view of a third embodiment of a hammer in accordance with the present invention;

FIG. 8 is another partially exploded perspective view of the hammer in FIG. 7;

FIG. 9 is a partially exploded perspective view of a fourth embodiment of a hammer in accordance with the present invention;

FIG. 10 is another partially exploded perspective view of the hammer in FIG. 9;

FIG. 11 is a partially cross sectional side view of the hammer in FIG. 9; and

FIG. 12 is a perspective view of a pulling unit of the hammer in FIG. 9.

### DETAILED DESCRIPTION OF PREFERRED EMBODIMENT

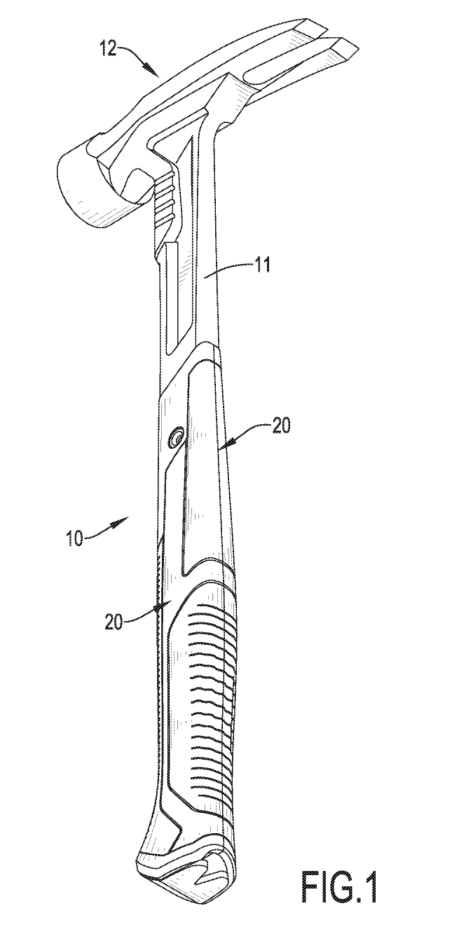

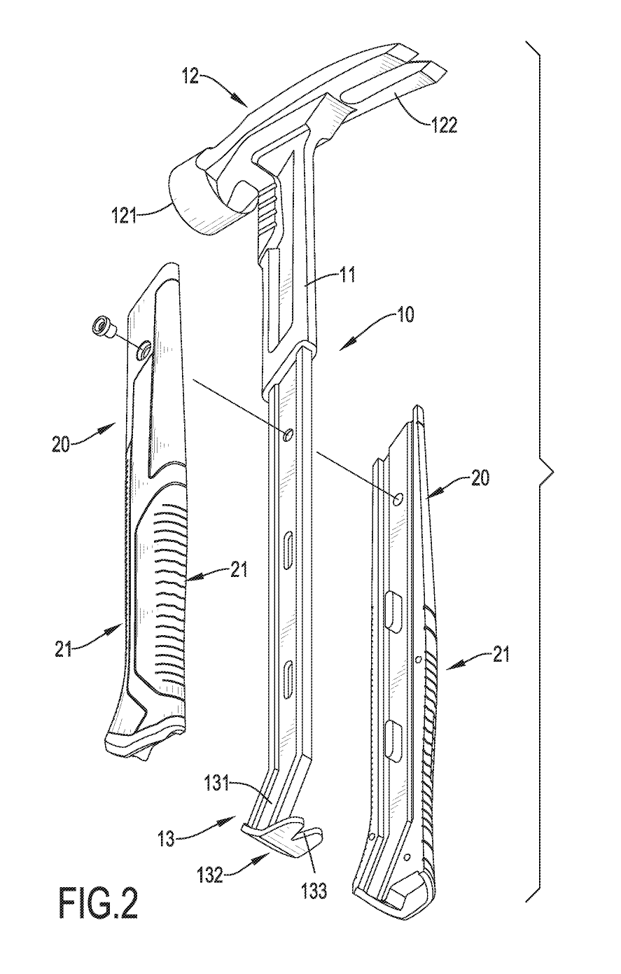

The present invention provides a hammer with a nail puller With reference to FIGS. 1 and 2, a first embodiment of a hammer in accordance with the present invention has a main unit 10 and two handle covers 20 mounted on the main unit 10.

With reference to FIGS. 1 and 2, the main unit 10 is a single and integrated component in the first embodiment. The main unit 10 has a handle 11, a striking head 12, and a nail puller 13. The handle 11 has a lengthwise direction, a first end, and a second end. The first end of the handle 11 and the second end of the handle 11 are opposite in the lengthwise direction of the handle 11. The striking head 12 is disposed at and connected to the first end of the handle 11. The striking head 12 has a striking face 121 and a claw 122 respectively facing to opposite directions.

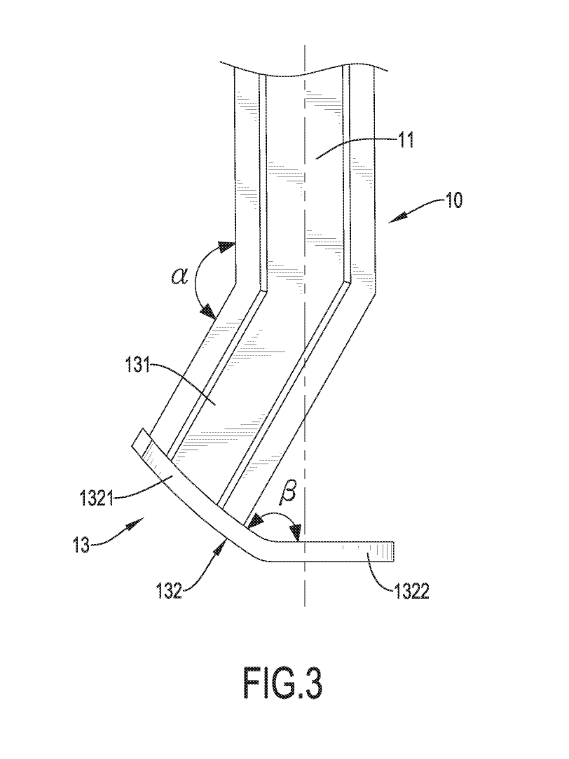

With reference to FIGS. 2 and 3, the nail puller 13 is disposed at the second end of the handle 11. The nail puller 13 has an extending section 131, a pulling unit 132, and an opening 133. The extending section 131 is formed at the second end of the handle 11 and is oriented relative to the handle 11 by an angle α. The pulling unit 132 has a joint portion 1321 and a pulling portion 1322. The joint portion 1321 is formed at the extending section 131 of the nail puller 13 and makes the extending section 131 disposed between the handle 11 and the joint portion 1321. The pulling portion 1322 is connected to the joint portion 1321 of the pulling unit 132. The pulling portion 1322 is oriented relative to the joint portion 1321 by an angle β. The opening 133 is formed through the pulling portion 1322 of the pulling unit 132.

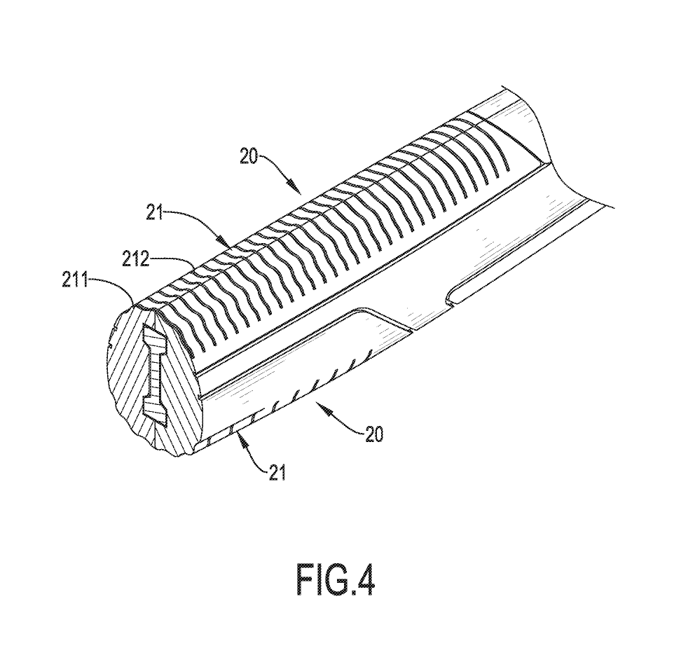

With reference to FIGS. 2 and 4, the two handle covers 20 are connected to each other. The handle 11 is disposed between the two handle covers 20. Each one of the two handle covers 20 has two gripping portions 21. Each one of the two gripping portions 21 has multiple corrugated protrusions 211 and multiple slits 212. The multiple corrugated protrusions 211 are parallel and extend along the lengthwise direction of the handle 11. The multiple slits 22 are parallel, are disposed along the lengthwise direction of the handle 11, and extend across the multiple corrugated protrusions 211.

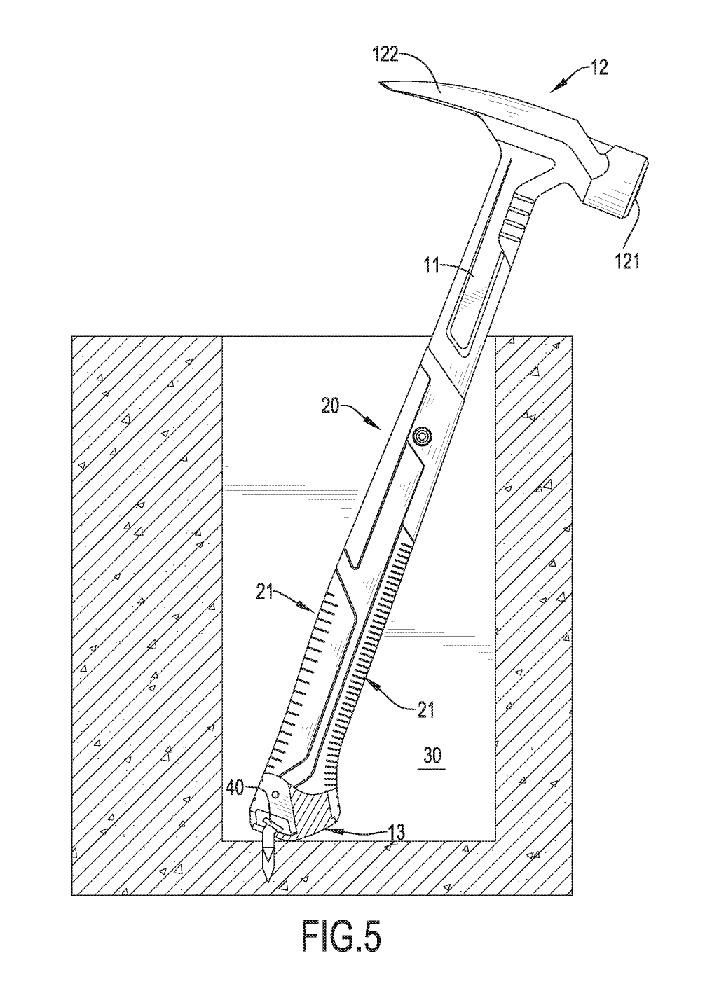

With reference to FIG. 5, the nail puller 13 disposed at the second end of the handle 11 is thinner than the striking head 12, and is much more suitable for operating in a small space 30 than the claw 122 of the striking head 12. The nail puller 13 may be inserted into the small space 30 and hook a fixed nail 40. When the main unit 10 is rotated in the clockwise direction as shown in FIG. 5, the nail 40 may be removed from the small space 30. Both the angle α defined between the handle 11 and the extending section 131 of the nail puller 13 and the angle β defined between the joint portion 1321 and the pulling portion 1322 of the pulling unit 132 can make the hammer even more suitable for operating in a smaller space. The multiple corrugated protrusions 211 of the gripping portion 21 of each one of the two handle covers 20 reduces an contact area between the hammer and the hand of the user, lowers impact delivered from the sweeping hammer, and can absorb vibration transferred to the hand of the user. The multiple slits 212 also reduce the contact area between the hammer and the hand of the user and can mitigate vibration transferred to the hand of the user as well.

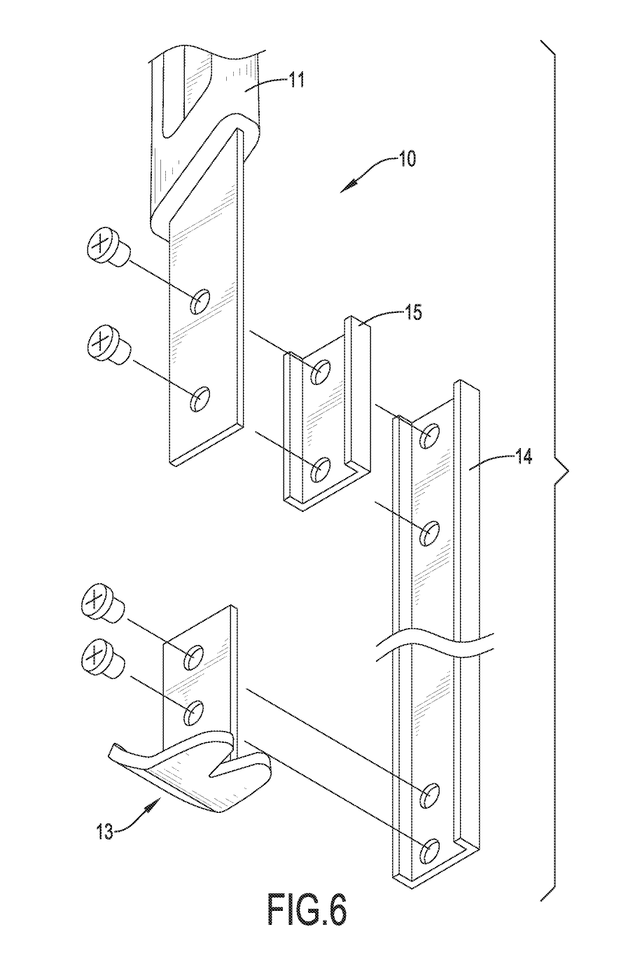

With reference to FIG. 6, a second embodiment of a hammer in accordance with the present invention is substantially the same as the first embodiment except for the following features. The nail puller 13 is detachably connected to the handle 11. In the second embodiment, the main unit 10 further has an assembling unit 14 and a buffer 15. The handle 11 has a connecting section with a thin thickness at the second end of the handle 11.

The assembling unit 14 is disposed between the handle 11 and the nail puller 13. The assembling unit 14 is connected both to the handle 11 and the nail puller 13 by rivets. The buffer 15 is flexible and may be made of rubber or silicon. The buffer 15 is disposed between the handle 11 and the assembling unit 14. The buffer 15 is passed through by the rivets and is clamped between the connecting section of the handle 11 and the assembling unit 14. The buffer 15 is designed according to an outline of the connecting section of the handle 11 and has a cross-section in a U shape.

In the second embodiment, the nail puller 13 and the handle 11 are two separate components that can interfere with impact and vibrations transferring from the hammer during its sweeping. Furthermore, the buffer 15 arranged between the handle 11 and the assembling unit 14 may absorb vibrations due to impacting in use.

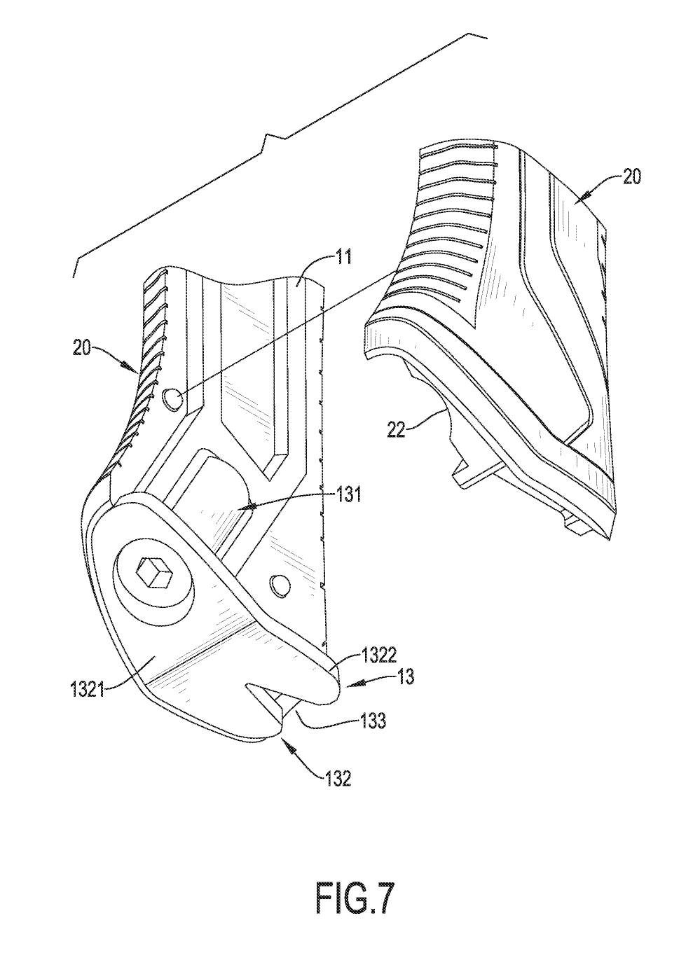

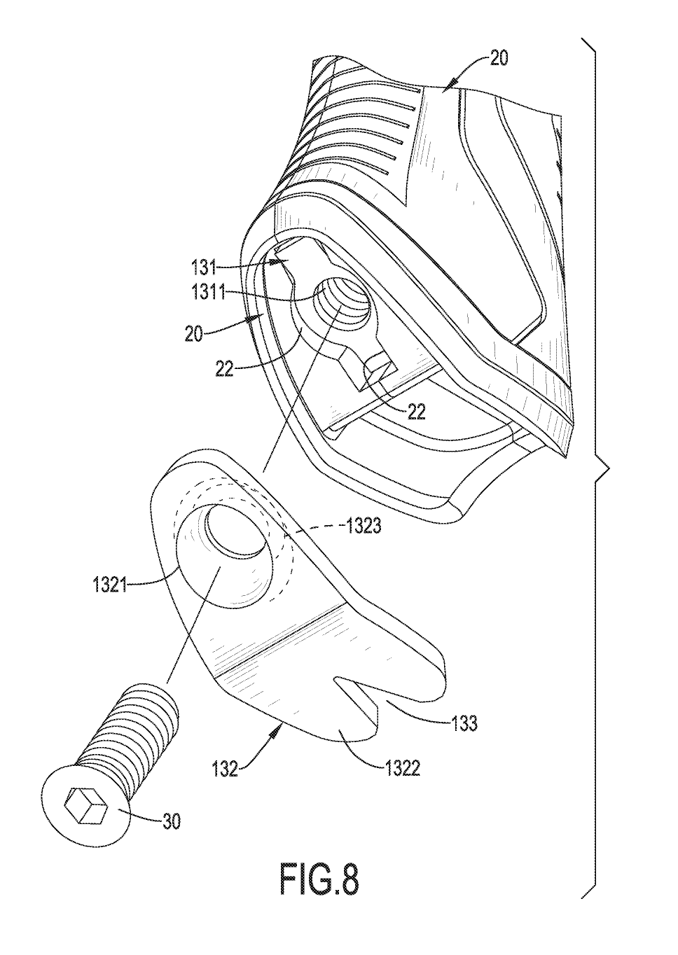

With reference to FIGS. 7 and 8, a third embodiment of a hammer in accordance with the present invention is substantially the same as the first embodiment and the second embodiment. In the third embodiment, the extending section 131 of the nail puller 13 connected to the handle 11 has a bottom end and a threaded hole 1311. The bottom end of the extending section 131 is distal from the handle 11. The threaded hole 1311 is formed at the bottom end of the extending section 131. The pulling unit 132 of the nail puller 13 is connected to the bottom end of the extending section 131 and is passed through by a bolt 30 that screwed with the threaded hole 1311. The pulling unit 132 has a protrusion 1323 formed on the joint portion 1321 of the pulling unit 132. Each one of the two handle cover 20 has an indention 22 formed at a bottom of the handle cover 20. Two indentions 22 of the two handle covers 20 are formed as a receiving recess to accommodate the protrusion 1323.

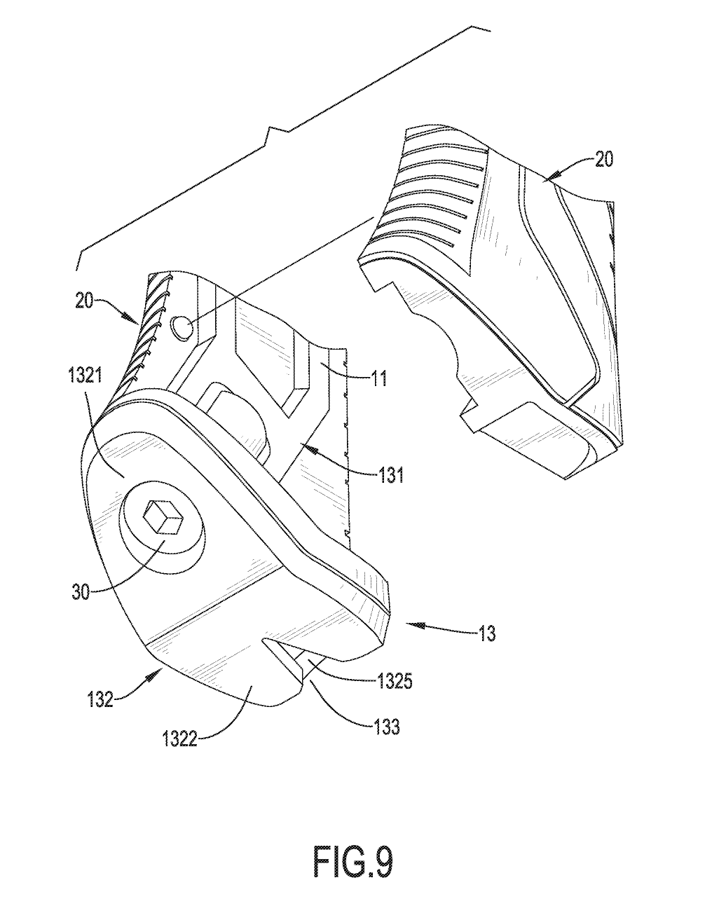

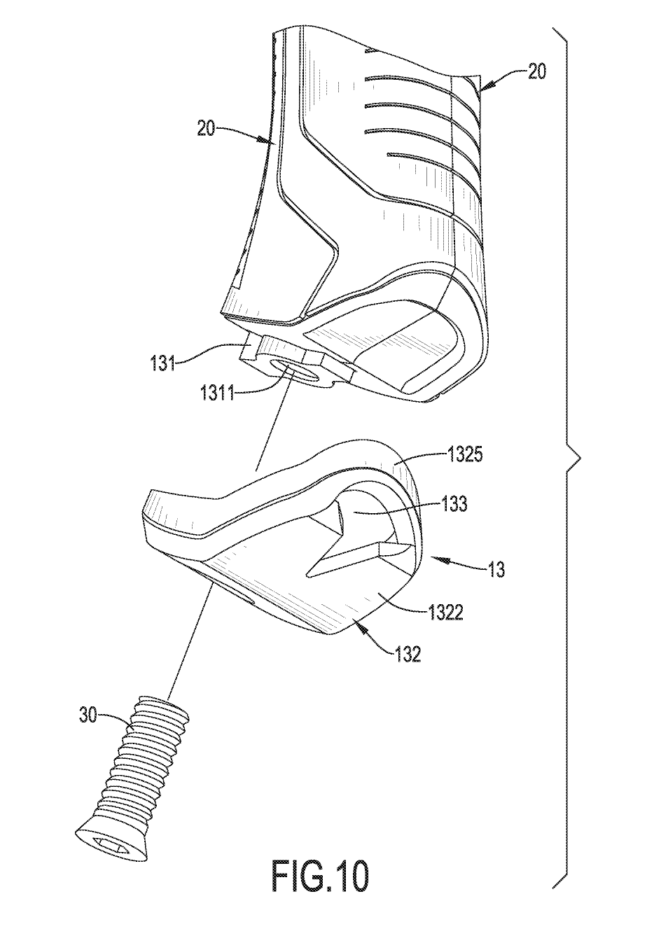

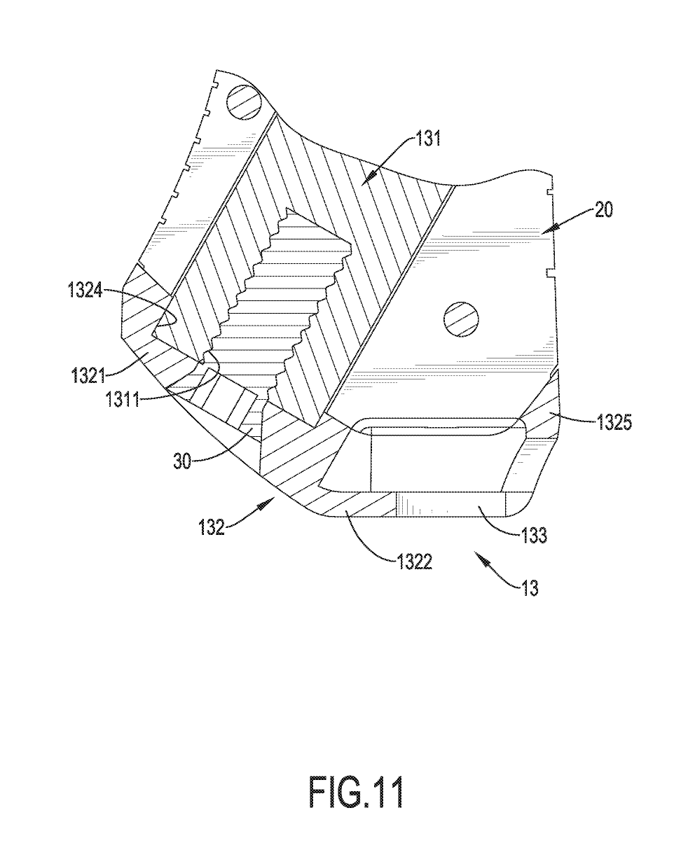

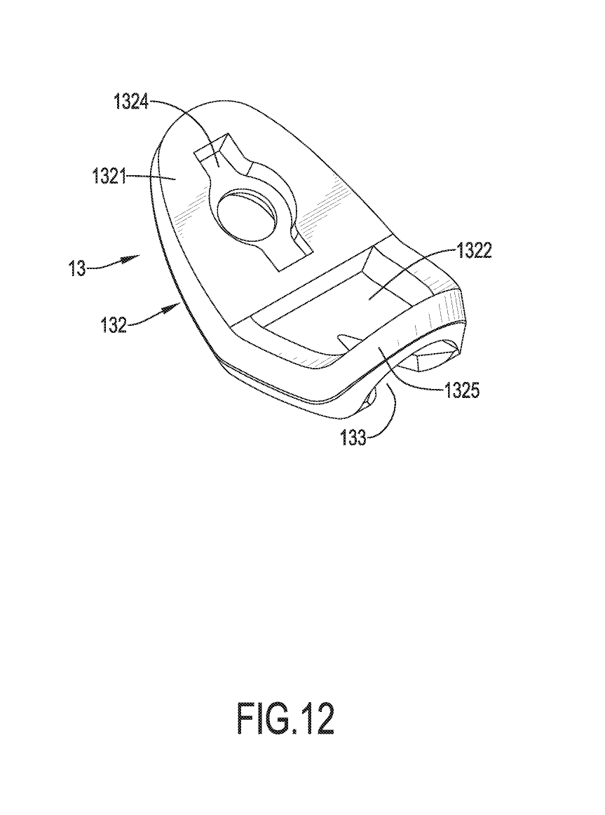

With reference to FIGS. 9 to 12, a fourth embodiment of a hammer in accordance with the present invention is substantially the same as the third embodiment. In the fourth embodiment, the pulling unit 132 is connected to the bottom end of the extending section 131 that connected to the handle 11. The pulling unit 132 is passed through by a bolt 30 that screwed with the threaded hole 1311 of the extending section 131. Instead of having the protrusion 1323, the pulling unit 132 has a positioning recess 1324. The positioning recess 1324 is formed in the joint portion 1321 of the pulling unit 132 and engages with the bottom end of the extending section 131. The positioning recess 1324 makes the pulling unit 132 securely connected to the extending section 131. The pulling unit 132 further has a crossing section 1325. The crossing section 1325 is formed on the pulling portion 1322 of the pulling unit 132 and extends across the opening 133 of the nail puller 13.

Even though numerous characteristics and advantages of the present invention have been set forth in the foregoing description, together with details of the stricture and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A hammer comprising:
a main unit having
a handle having
a lengthwise direction;
a first end; and
a second end opposite the first end of the handle in the lengthwise direction of the handle;
a striking head disposed at the first end of the handle; and
a nail puller disposed at the second end of the handle and having a pulling unit having an opening for receiving a nail.

2. The hammer as claimed in claim 1, wherein
the nail puller has an extending section connecting to the second end of the handle and disposed between the handle and the pulling unit; and
the pulling unit is connected to the extending section.

3. The hammer as claimed in claim 2, wherein
the pulling unit has
a joint portion connected to the extending section of the nail puller;
a pulling portion connected to the joint portion; and
an angle defined between the joint portion and the pulling portion; and
the opening of the pulling unit is formed through the pulling portion of the pulling unit.

4. The hammer as claimed in claim 3, wherein the extending section is oriented relative to the handle by an angle.

5. The hammer as claimed in claim 4, wherein the hammer further has two handle covers connected to each other, and the handle is disposed between the two handle covers.

6. The hammer as claimed in claim 5, wherein
each one of the two handle covers has at least one gripping portion each having
multiple corrugated protrusions extending along the lengthwise direction of the handle; and
multiple slits being parallel, disposed along the lengthwise direction of the handle, and extending across the multiple corrugated protrusions.

7. The hammer as claimed in claim 6, wherein the nail puller is detachably connected to the handle.

8. The hammer as claimed in claim 7, wherein the main unit further has
an assembling unit disposed between the handle and the nail puller and connected both to the handle and the extending section of the nail puller; and
a buffer being flexible and clamped between the handle and the assembling unit.

9. The ham as claimed in claim 8, wherein the buffer has a cross-section in a U shape.

10. The hammer as claimed in claim 6, wherein
the extending section has a threaded hole formed at a bottom end of the extending section that being distal from the handle; and
the palling unit of the nail puller is connected to the bottom end of the extending section and is passed through by a bolt that screwed with the threaded hole.

11. The hammer as claimed in claim 10, wherein
each one of the two handle cover has an indention formed at a bottom of the handle cover;
two indentions of the two handle covers are formed as a receiving recess; and
the pulling unit has a protrusion formed on the joint portion of the pulling unit and extending into the receiving recess.

12. The hammer as claimed in claim 10, wherein
the pulling unit has a positioning recess formed in the joint potion of the milling unit; and
the bottom end of the extending section engages with the positioning recess.

13. The hammer as claimed in claim 12, wherein
the pulling unit has a crossing section formed on the pulling portion of the pulling unit; and
the crossing section extends across the opening of the nail puller.
